(19) United States
(12) Patent Application Publication
(10) Pub. No.: US 2023/0164081 A1
(43) Pub. Date: May 25, 2023

(54) TRAFFIC DETECTION FOR APPLICATION DATA UNIT MAPPING

(71) Applicant: Apple Inc., Cupertino, CA (US)

(72) Inventors: Ralf Rossbach, Munich (DE); Haijing Hu, Los Gatos, CA (US); Huarui Liang, Beijing (CN); Jan K. Ellenbeck, Gruenwald (DE); Robert Zaus, Munich (DE); Sabine Roessel, Munich (DE); Shu Guo, Beijing (CN); Sudeep Manithara Vamanan, Nuremberg (DE); Weidong Yang, San Diego, CA (US)

(73) Assignee: Apple Inc., Cupertino, CA (US)

(21) Appl. No.: 17/978,143

(22) Filed: Oct. 31, 2022

Related U.S. Application Data
(60) Provisional application No. 63/282,886, filed on Nov. 24, 2021.

(51) Int. Cl. H04L 47/2416; H04W 28/02; H04L 47/34

(52) U.S. Cl. CPC H04L 47/2416; H04W 28/0268; H04L 47/34

(57) ABSTRACT

The present application relates to devices and components including apparatuses, systems, and methods for technologies for traffic detection for application data unit mapping in wireless networks.

### CROSS-REFERENCE TO RELATED APPLICATION

This application claims the benefit of U.S. Provisional Patent Application No. 63/282,886, filed on Nov. 24, 2021, which is herein incorporated by reference in its entirety for all purposes.

### BACKGROUND

Third Generation Partnership Project (3GPP) Technical Specifications (TSs) define standards for New Radio (NR) wireless networks. One area of study for developing these TSs is providing support for low latency communication and extended reality (XR) applications.

### BRIEF DESCRIPTION OF THE DRAWINGS

FIG. 1 illustrates a network environment in accordance with some embodiments.

FIG. 2 illustrates a quality of service (QoS) classification operation in accordance with some embodiments.

FIG. 3 illustrates another QoS classification operation in accordance with some embodiments.

FIG. 4 illustrates a real-time protocol (RTP) packet structure in accordance with some embodiments.

FIG. 5 illustrates a secure RTP (SRTP) packet in accordance with some embodiments.

FIG. 6 illustrates a secure real-time control protocol (SRTCP) packet in accordance with some embodiments.

FIG. 7 illustrates parallel hint track and media track in accordance with some embodiments.

FIG. 8 illustrates an operational flow/algorithmic structure in accordance with some embodiments.

FIG. 9 illustrates another operational flow/algorithmic structure in accordance with some embodiments.

FIG. 10 illustrates another operational flow/algorithmic structure in accordance with some embodiments.

FIG. 11 illustrates a user equipment in accordance with some embodiments.

FIG. 12 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

As briefly introduced above, one study area for developing 3GPP TSs is supporting low-latency communication and XR applications. Related key performance indicators (KPIs) and quality of service (QoS) aspects may specify radio access network (RAN) support for enhanced granularity for QoS, application data unit (ADU)-based QoS, and XR-specific QoS parameters. QoS flow handling and corresponding data radio bearer (DRB) control may also be specified.

There may be a number of potential areas of development with respect to application awareness in RAN or CN operation. For example, it may be beneficial for a next-generation node B (gNB) or user plane function (UPF) to identify XR traffic characteristics and application layer attributes to be aware of QoS flow association, frame-level QoS, ADU-based QoS, and XR-specific QoS. Further, application layer information such as, for example, frame rate, delay, and packet importance, may aid XR-specific handling (for example, scheduling and radio bearer handling). Embodiments of the present disclosure describe aspects to facilitate network node's awareness of ADUs to enable enhanced QoS through the network.

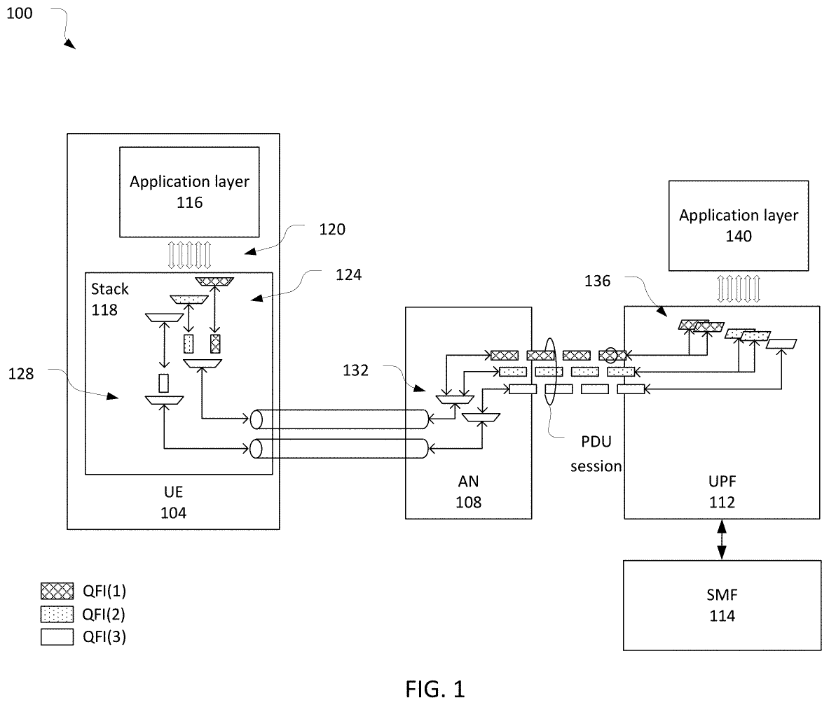

FIG. 1 illustrates a network environment 100 in accordance with some embodiments. The network environment 100 may include a UE 104 communicatively coupled with an access node 108. The UE 104 and the access node 108 may communicate over air interfaces compatible with 3GPP TSs such as those that define Fifth Generation (5G) NR system standards. The access node 108 may be a gNB to provide one or more 5G New Radio (NR) cells that present NR user plane and control plane protocol terminations toward the UE 104.

The network environment 100 may further include a UPF 112 of a core network (CN), for example, a 5^{th} Generation Core network (5GC). The UPF 112 may be responsible for routing and forwarding user-plane packets between the access node 108 and an external network. The UPF 112 may handle the user plane path of protocol data unit (PDU) sessions. The UPF 112 may be coupled with a session management function (SMF) 114 that configures traffic steering, QoS control and policy related functions at the UPF 112, performs PDU session management, IP address allocation, general packet radio service tunneling protocol-user plane (GTP-U) tunnel management, selection and control of user plane functions, and downlink notification management.

Various components of the network environment 100 may perform QoS mapping operations for transmissions between application layer 116 and application layer 140. Except as otherwise described herein, these mapping operations may be similar to those described in the QoS model of clause 5.7 of 3GPP TS 23.501 v17.2.0 (2021-09).

The QoS mapping may be performed with a two-step approach. In step 1, QoS flow classification may be performed to classify packets as part of a traffic detection (or application detection) process for QoS enforcement in a 5G system. The packets may be mapped to one or more QoS flows. One PDU session may include a plurality of QoS flows. In step 2, QoS flows may be mapped to DRBs for transmission over resources of an access network. The UE 104 may perform step 1 at 124 and step 2 at 128; the AN 108 may perform step 2 at 132; and the UPF 112 may perform step 1 at 136.

In the uplink, the application layer 116 of the UE 104 may provide data packets in one or more IP flows 120 of a service data flow (SDF) to a stack 118. While IP flows are described throughout, embodiments may be equally applicable to other types of packet flows (for example, Ethernet). An SDF may be a flow of packets that represent a service being delivered to the subscriber. For example, an SDF may be a flow of audio/video packets that provide a streaming media service to a subscriber. An SDF may have one or more packet flows.

The stack 118 represents access stratum and non-access stratum protocol layers of the UE 104 that provide for communicating over the radio-access and core networks. The stack 118 may perform QoS flow classification at 124 based on QoS rules by mapping uplink packets from the IP flows to QoS flows and applying QoS flow marking. All packets of a QoS flow may be marked with the same QoS flow identifier (QFI). FIG. 1 illustrates three QoS flows corresponding with QFI(1), QFI(2), and QFI(3).

Typically, traffic associated with the same QFI will receive the same QoS treatment. The QFI may be used as a U-plane marking on the N3 interface (between RAN and UPF) and N9 interface (within UPF) and may be unique within a PDU session. In some instances, the QFI may also be carried in a radio header over the radio interface (Uu).

The stack 118 may also perform the QoS flow-to-DRB mapping at 128 to map the QoS flows to access network resources. The mapping at 128 may be an access stratum operation performed by for example, a service data adaptation protocol (SDAP) layer of the stack 118. Different QoS flows may be mapped to the same or different DRBs (for example, n:1 or 1:1 mapping). Several QoS flows belonging to the same PDU session may be mapped to the same DRB. However, QoS flows belonging to different PDU sessions may not be mapped to the same DRB. The RAN may add new DRB with corresponding QFI mappings to fulfill QoS characteristics of a QoS flow. The UE 104 may determine uplink data QoS binding (association between QoS flows and DRBs) based on explicit QoS signaling or reflective QoS signaling based on downlink data QoS marking.

The AN 108 may perform DRB-to-QoS flow mapping at 132 and the UPF 112 may perform QoS flow to IP flow mapping at 136. The IP flows may be provided to application layer 140 that may reside at a device in communication with the UE 104. The application layer 140 may be in a server, another UE, or another XR-user connected to the Internet over, for example, a digital subscriber line or a wireless local area network.

In the downlink, the UPF 112 may perform QoS classification at 136 by classifying the IP packets for QoS flow marking and other actions based on packet detection rules (PDRs).

After the UPF 112 maps the IP flows to the QoS flows at 136, the AN 108 may perform QoS flow-to-DRB mapping at 132 to map the QoS flows to access network resources. The UE 104 may perform DRB-to-QoS flow mapping at 128 and QoS flow to IP flow mapping at 124.

The application layers 116/140 may operate on application data units (ADUs), which may be considered the smallest independently usable data unit. One ADU may contain a plurality of lower-layer packets. For example, one ADU may include more than one RTP/IP packets. In general, there may be a 1:1 mapping between RTP and IP packets. However, in some cases one RTP packet may be transmitted in a plurality of IP packets using IP fragmentation. This may be based on a maximum transmission unit (MTU) size available on a link. Further, some RTP payload formats may allow aggregation a multiple ADUs into a single RTP payload.

An ADU may be specified for coding formats and RTP payload formats in a 3GPP file format (3GP) file. For audio and speech, an ADU may be specified as a coded frame intended for transport. For H.263 video compression standard, an ADU may include an entire RTP payload. For H.264 advanced video coding (AVC) standard or H.265 high-efficiency video coding (HEVC) standard, an ADU may be a network adaptation layer unit (NALU). For timed text, an ADU may include any of the type 1-5 RTP payload units. Other payload formats may exist in, for example, RFCs, 3GP files, etc., or can be specific to an application.

The application layers 116/140 may operate on ADUs or larger data bursts (represented by a bitstream) where a data burst may include a set of ADUs. A single ADU in the set may get packetized into a plurality of lower layer data packets that are smaller than the ADU. For example, an ADU may be packetized into a plurality of RTP packets mapped to a plurality of IP packets/packet data convergence protocol (PDCP) service data units (SDUs).

Embodiments of the present disclosure extend processes of step 1 of the QoS mapping operations to enable ADU-based QoS and to facilitate traffic detection for QoS enforcement through a network.

Some aspects of the disclosure describe creation of suitable PCC rules, PDRs, and QoS rules to allow a more granular differentiation and classification of traffic. This may be based on the ADU to address scenarios in which application layer traffic runs over RTP and existing packet filters are not able to detect an ADU. This may be beneficial in situations such as video traffic that includes classification of intra-coded picture (I) frames and predicted picture (P) frames, for example, to enable different treatment of these frames at lower layers.

Further aspects of the disclosure may be used with secure RTP (SRTP) in which part of the traffic information is encrypted. This may happen in scenarios in which ADU differentiation happens based on the RTP payload, such as for video traffic over H.264/H.265 report of the information is contained in a network abstraction layer (NAL) unit. Embodiments describe techniques to avoid or reduce reliance on processing the encrypted data content.

Embodiments describe 5G systems utilizing traffic detection to enforce QoS based on ADUs that may be generated with respect to RTP/SRTP based services. These services may include XR and immersive multimedia services that run over IP multimedia subsystem (IMS), multimedia telephony services for IMS (MTSI), or web real-time communications (webRTC). MTSI uses RTP, where the RTP payload is typically not encrypted. WebRTC and streaming services may use SRTP. A number of other multimedia applications including conferencing and immersive audio/video may also utilize RTP/SRTP.

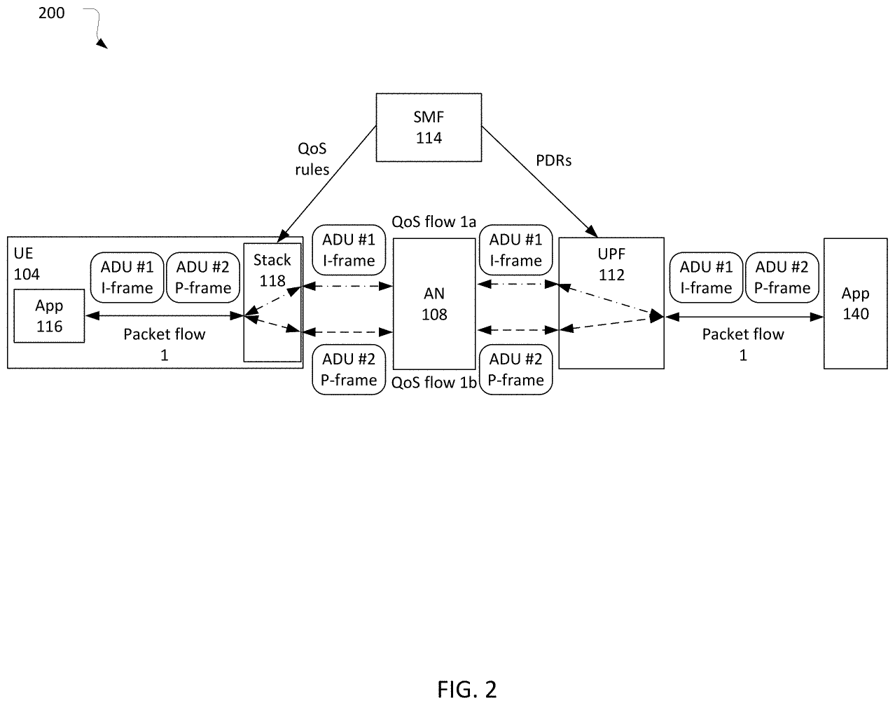

FIG. 2 illustrates a QoS classification operation 200 of the network environment 100 in accordance with some embodiments.

For a given SDF, the binding of service requirements and QoS flows may be based on policy and charging control (PCC) rules provided to the SMF 114 by the policy control function (PCF) or application function (AF) of the 5G core network. Except as otherwise described herein, this may be consistent with corresponding descriptions in 3GPP TS 23.501 v17.2.0 (2021-09-24), 3GPP TS 23.502 v17.2.1 (2021-09-29), and 3GPP TS 23.503 v17.2.0 (2021 Sep. 24).

The SMF 114 performs the binding of PCC rules to QoS flows based on the QoS and service requirements. The SMF 114 may generate packet filters based on the PCC rules. The packet filters may be provided to the UPF 112 as PDRs and to the stack 208 as QoS rules.

For pre-defined PCC rules, traffic detection filters (for example, packet filters) to be used in the UPF 112 may be configured either in the SMF 114 and provided to the UPF 112 as SDF filters or be configured in the UPF 112 as an application detection filter identified by an application identifier.

The packet filters, which may incorporate awareness of ADUs, may be used by the UPF 112 and the stack 208 to perform step 1 of the QoS mapping based on RTP fields or extended rules. In this manner, the mapping of packet flows to the QoS flows (and vice versa) may be done in a manner that provides network components visibility to ADUs, which may enable efficient routing operations.

In particular, with respect to QoS classification 200, the UPF 112 may identify packets of a first ADU (ADU #1) that correspond to an I-frame and packets of a second ADU (ADU #2) that correspond to a P-frame. Both ADUs may belong to a common packet flow (packet flow #1). The UPF 112 may map ADU #1 to a first QoS flow (for example, QoS flow 1a) and may map ADU #2 to a second QoS flow (for example, QoS flow 1b) based on a PDR. In this manner, different packets of a packet flow may be mapped to different QoS flows based on the ADUs with which the individual packets are associated.

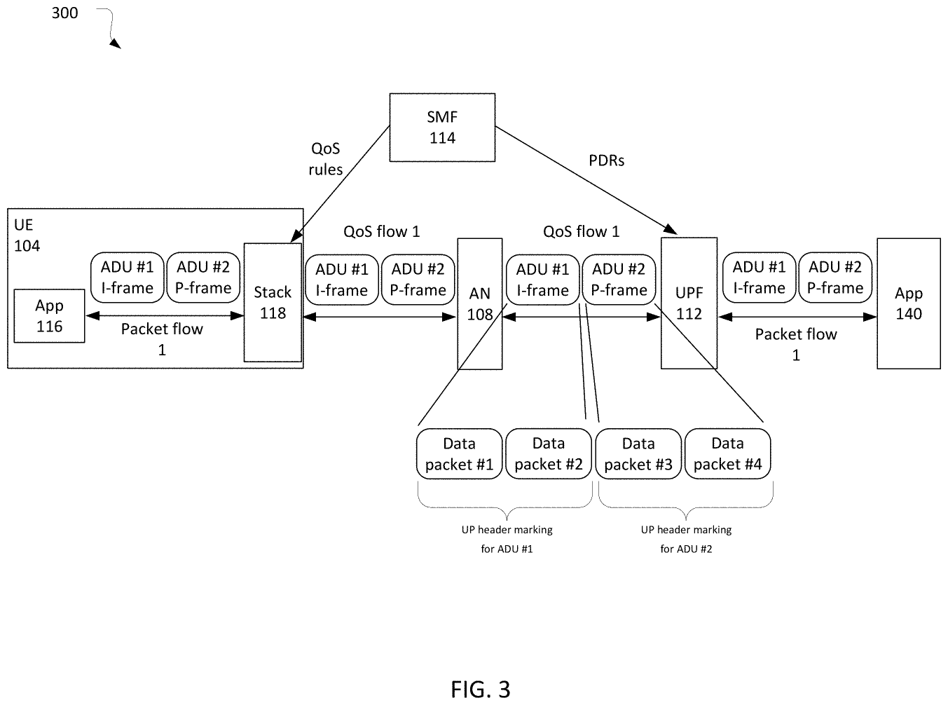

FIG. 3 illustrates a QoS classification operation 300 of the network environment 100 in accordance with other embodiments. Similar to that described above, the SMF 114 may provide packet filters to the UPF 112 as PDRs and to the stack 118 as QoS rules. In contrast to the QoS classification operation 200, the QoS classification operation 300 maps both ADU #1 and ADU #2 to one QoS flow (QoS flow 1). To facilitate traffic detection in the core network and the UE 104, the UPF 112 may mark user plane packet headers with a new field for the purpose of ADU classification within a QoS flow. In this manner, if one QoS flow is used for different types of ADUs, a subflow granularity may still be achieved based on the marking.

Consider, for example, that ADU #1 includes data packet #1 and data packet #2 and ADU #2 includes data packet #3 and data packet #4. The UPF 112 may mark the headers of data packet #1 or #2 in a manner that indicates these data packets are associated with ADU #1. Similarly, the UPF 112 may mark the headers of data packets #3 or #4 in a manner that indicates these data packets are associated with ADU #2. As will be described in further detail below, some or all of the data packets associated with a particular ADU may be marked in a manner to enable identification of an association of all the data packets to the ADU.

The header marking to provide subflow granularity may be applicable to user plane traffic transmitted over an N3 interface between the UPF 112 and the AN 108, user plane traffic between the AN 108 and the UE 104, user plane traffic between an centralized unit and an AN distributed unit, user plane traffic between integrated access and backhaul nodes, or user plane traffic between different ANs.

As described above, a packet filter set may be used in the QoS rule and the PDR to identify one or more packet flows. A packet filter set, which may be based on a PCC rule, may include a number of packet filters to identify the packet flows. These packet filters, which are traditionally arranged as a 2-tuple or a 5-tuple, may include source/destination IP address or IPv6 prefix; source/destination port number; protocol ID of the protocol above IP/next header type; a type of service (TOS) (IPv4) or traffic class (IPv6) and mask; a flow label (IPv6); a security parameter index; or a packet filter direction. Except as otherwise described herein, the packet filter set may be similar to that described in clause 5.7.6 of 3GPP TS 23.501.

Some embodiments describe extending the packet filter set by including additional packet filters, which may be used for RTP- or MTSI-based services. These additional packet filters may include an RTP header-based condition; an RTP payload-based condition; or an RTCP header-based condition. One or more of these additional packet filters may be used in conjunction with any combination of the existing packet filters described in, for example, 3GPP TS 23.501.

It may be noted that MTSI does not encrypt the RTP payload.

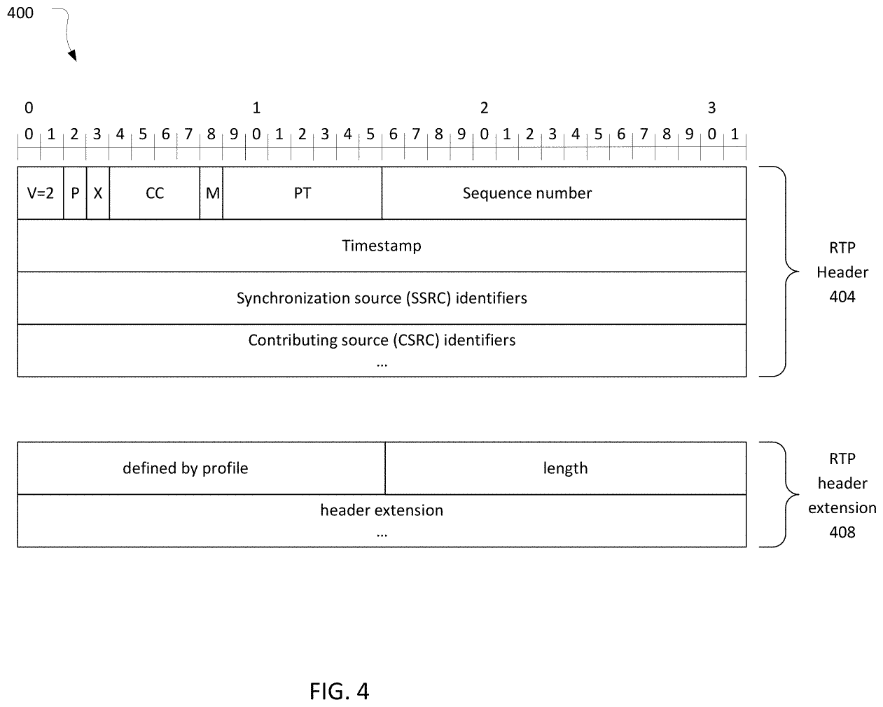

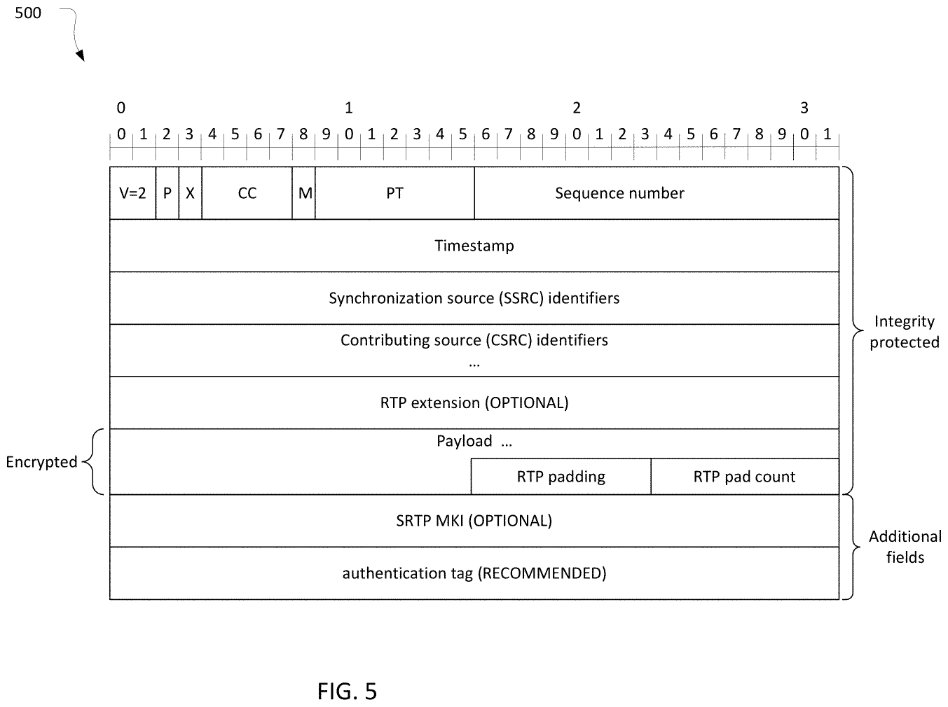

FIGS. 4-5 describe packet structures to facilitate the discussion of the RTP header-based condition, the RTP payload-based condition, and the RTCP header-based condition in the following embodiments.

FIG. 4 is an RTP packet 400 that includes an RTP header 404 and an RTP header extension 408 in accordance with some embodiments. Some of the fields relevant to embodiments of the present disclosure are described herein. Other fields of the RTP packet 400 may be similar to like-named RTP fields described by Internet Engineering Task Force (IETF) in Request for Comment (RFC) 3550, RTP: A Transport Protocol for Real-Time Applications (July 2003).

The RTP header 404 may include a one-bit marker (M) field. “The interpretation of the marker may be defined by a profile. It is intended to allow significant events such as frame boundaries to be marked in the packet stream. A profile MAY define additional marker bits or specify that there is no marker bit by changing the number of bits in the payload type (PT) field (see Section 5.3).” RFC 3550, section 5.1.

The PT field may include seven bits. “This field identifies the format of the RTP payload and determines its interpretation by the application.” RFC 3550, section 5.1.

Constants defined in RFC 3550 may be defined. “The RTP payload type (PT) constants are defined in profiles [for example, audio and video application profiles in IETF RFC 3551, RTP Profile for Audio and Video Conferences with Minimal Control (July 2003)] rather than [RFC 3550]. However, the octet of the RTP header which contains the marker bit(s) and payload type MUST avoid the reserved values 200 and 201 (decimal) to distinguish RTP packets from the RTCP SR and RR packet types for the header validation procedure described in Appendix A.1. For the standard definition of one marker bit and a 7-bit payload type field as shown in [RFC 3550], this restriction means that payload types 72 and 73 are reserved.” RFC 3550, section 12.

The sequence number field may include 16 bits. “The sequence number increments by one for each RTP data packet sent, and may be used by the receiver to detect packet loss and to restore packet sequence.” RFC 3550, section 5.1.

The timestamp field may include 32 bits. “The timestamp reflects the sampling instant of the first octet in the RTP data packet.” RFC 3550, section 5.1.

The extension (X) field may include one-bit. If the X field is set to one, a variable length header extension, for example, header extension 408, is appended to the RTP header 404. “The header extension contains a 16-bit length field that counts the number of 32-bit words in the extension, excluding the four-octet extension header (therefore zero is a valid length). Only a single extension can be appended to the RTP data header.” RFC 3550, section 5.3.1.

Section 5.3 of RFC 3550 defines profile-specific modifications to the RTP header. For example, “in keeping with the [application level framing] ALF design principle, the header may be tailored through modifications or additions defined in a profile specification. The marker bit and payload type field carry profile-specific information . . . The octet containing these fields may be redefined by a profile to suit different requirements.” RFC 3550, section 5.3. Some embodiments describe profile specific modifications to the RTP header to enable ADU based traffic detection. The modifications may be implemented through changes in the RTP profiles defined in RFC 3551 or in 3GPP specific profile information for use over RTP/SRTP defined in, for example, 3GPP TS 26.114 v17.2.0 (2021 Sep. 24), TS 26.234 v16.2.0 (2020 Dec. 23), or TS 26.244 v16.1.0 (2020 Sep. 25).

FIG. 5 is an SRTP packet 500 in accordance with some embodiments. The fields of the SRTP packet 500 may be similar to those described in IETF RFC 3711 (March 2004) unless otherwise noted.

The header of the SRTP packet 500 may be integrity protected (for example, authenticated) with an authentication tag, having authentication data, added to the end of the packet that a receiver can read and compare for authentication purposes. While the RTP header is integrity protected, it is not encrypted. Therefore, it can be read in flight.

The RTP payload (including the RTP padding, when present) may be encrypted.

The SRTP packet may also include a master key identifier (MM) appended to the RTP packet for key management purposes.

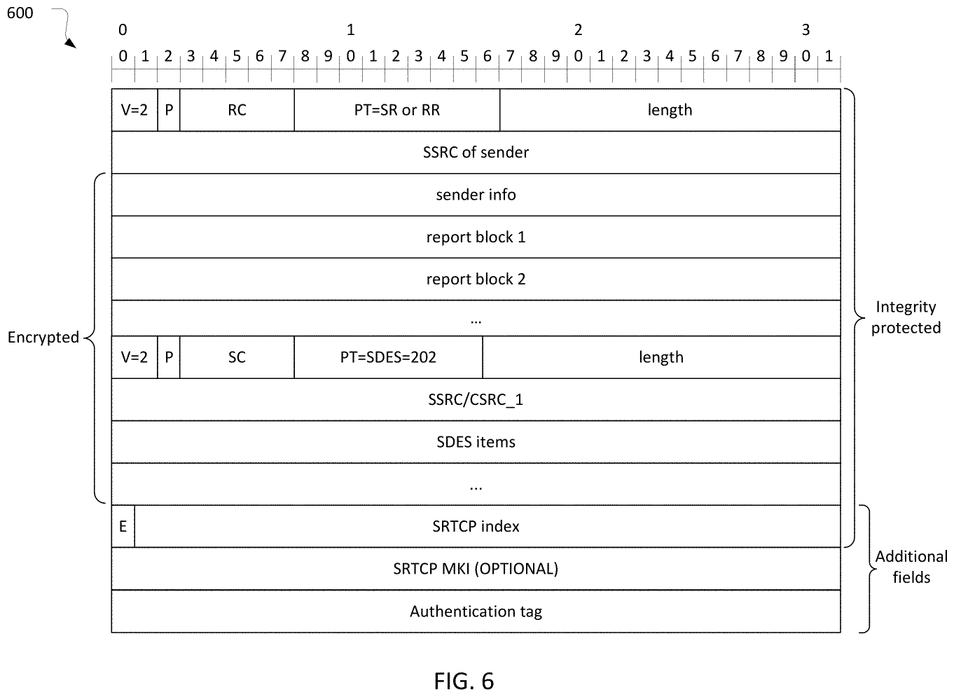

FIG. 6 is a secure real time control protocol (SRTCP) packet 600 in accordance with some embodiments. The fields of the SRTCP packet 600 may be similar to those described in IETF RFC 3711 (March 2004) unless otherwise noted.

The SRTCP packet 600 does not encrypt the RTCP header, but does encrypt the RTCP payload of the equivalent compound RTCP packet. The compound RTCP packet may be defined in RFC 3550 as the concatenated RTCP packets where multiple RTCP packets are sent together as a compound RTCP packet in a single packet of the underlying protocol. This may be enabled by the length field in the fixed header of each RTCP packet.

The authenticated portion of the SRTCP packet 600 may include the entire equivalent (eventually compound) RTCP packet, an encrypt (E) flag, and an SRTCP index. This may be done after any encryption has been applied to the payload.

The SRTCP packet 600 may include additional fields appended to the (compound) RTCP packet such as, for example, the SRTCP index, the E flag, and authentication tag, or an MM.

An RTP header-based condition for a packet filter set may be defined by one or more of the following eight options. Aspects of these options may be used separately or combined with aspects of other options as desired for a particular embodiment.

A first option may define a set of ADU types in an RTP header extension, for example, RTP header extension 408. The set of ADU types may be defined by using the header extension mechanism of RFC 3550 or the policy of RFC 3551, section 3. In some aspects, this option may be extended to define a structure that adds a set of parameters with information that describes an ADU. As a result, data traffic may indicate, in a header extension of the packet, a value of a type of ADU with which the packet is associated. The ADU type value may indicate a specific frame or slice type. For example, the ADU type value may indicate that the associated ADU is an I frame/slice, a P frame/slice, a bidirectional predicted picture (B) frame/slice, a switching (S) frame/slice, a switching I (SI) frame/slice, a switching P (SP) frame/slice, an instantaneous decoding refresh (IDR) frame, a non-IDR frame, an intra-random access picture (TRAP) frame, a non-IRAP frame, or a type of reference frame. It may be noted that slices are segments of a bitstream that can be reconstructed independently from other slices within the same picture.

In some embodiments, a value of the header extension may be used together with a PT value, which indicates the codec type (for example, H263, H264, H265, etc.), to determine the ADU type. For example, the header extension value may correspond to a generic ADU type, and a device may determine a specific ADU type with additional reference to the codec type indicated by the PT value.

The first option does not require examination of a payload header in an RTP payload in order to get the detailed ADU information for all frame/slice types.

A second option for defining an RTP header-based condition may be based on a marker bit in the RTP header that identifies a first or last packet associated with an ADU. The marker bit may be assumed to be set for the first or last RTP packet associated with an ADU. In this manner, the set marker bit may act as a delimiter that a device may rely on to identify the RTP packets associated with a particular ADU. The interpretation of the marker bit may be defined by a profile in, for example, RFC 3550, RFC 3551, IETF RFC 6184, RTP Payload Format for H264 Video (May 2011), or IETF RFC 7798, RTP Payload Format for High Efficiency Video Coding (HEVC) (March 2016).

A third option for defining an RTP header-based condition may be based on an additional marker bit provided in an RTP extension header. This may be done consistent with the options provided in RFC 3550. The additional marker bit may be designed to complement the marker bit of the second option. For example, if the marker bit in the RTP header identifies a last packet associated with an ADU, the marker bit in the RTP extension header may be used to identify a first packet associated with the ADU. Conversely, if the marker bit in the RTP header identifies a first packet associated with an ADU, the marker bit in the RTP extension header may be used to identify the last packet associated with the ADU. Setting marker bits to define both the first and last packet may facilitate faster identification and forwarding of packets pertaining to an ADU. This may be especially useful in scenarios in which an ADU may contain many RTP/IP packets and the traffic is associated with a low-latency objective.

A fourth option for defining an RTP header-based condition may be based on a packet number in unit (PNU) field in an RTP extension header. This may be done consistent with options provided in RFC 3550. The PNU field of an RTP packet may have value that indicates the number of the RTP packet within the ADU. In one aspect, a first packet of an ADU may start with a PNU value of “1,” which may be incremented in subsequent packets. This aspect may be used instead of using the marker to indicate the first packet as described above with respect to the second and third options. In another aspect, a first packet of an ADU may start with a PNU value set to the total number of RTP packets in the ADU and may be decremented for each subsequent packet until the PNU value of “1” is reached in the last RTP packet of the ADU. In another option of this aspect, a first packet of an ADU may start with a PNU value set to one less than the total number of RTP packets in the ADU and may be decremented for each subsequent packet until the PNU value of “0” is reached in the last RTP packet of the ADU. This aspect may be advantageous as a device will know upon receipt of the first or subsequent packet how many additional RTP packets to expect for the ADU. This aspect may be used instead of using the marker to indicate the last packet as described above with respect to the second and third options.

In some instances, the PNU value and the marker bit indicating the first or last packet may be used together. For example, if the PNU values increase, the marker bit may be used to indicate the last packet in the ADU. Conversely, if the PNU values decrease, the marker bit may be used to indicate the first packet in the ADU. If in-sequence delivery is assured and the marker bit is used instead of the PNU value for the first packet, the first PNU value, in the second packet of the ADU, may be set with one less than the total number of RTP packets in the ADU. Alternatively, the marker bit may be used together with the PNU value in the same (for example, first) packet.

In some aspects, only one RTP packet may be provided with a PNU value. The one RTP packet may be the first RTP packet or the last RTP packet. For example, a first RTP packet may be provided with a PNU value that is equal to the total number of RTP packets in an ADU. This may be used instead of the first marker. Thus, in addition to providing a delimiter, the PNU value may also provide a device with information as to a total number of RTP packets in the ADU.

A fifth option for defining an RTP header-based condition may be accomplished by defining a new payload type for ADUs of a same codec type but for different frame types. This may be done by using at least one of the following suboptions. In a first suboption, the new payload type may be defined by using a profile-specific modification to an RTP header as defined in, for example, RFC 3550, clause 5.3. In a second suboption, the new payload type may be defined by using payload types in the value range 96-127 dynamically defined through a suitable signaling protocol during communication establishment as defined in, for example, RFC 3551, clause 6. In a third suboption, the new payload type may be defined via a header extension similar to that described above with respect to the first option.

For example, a new payload type “H.264_key_frame” may be defined in addition to the existing H.264 payload format. A key frame may refer to an I-frame or IDR frame in H.264 (AVC) or an IRAP picture in H.265 (HEVC). Other ADU types (for example, IDR frame, non-IDR-frame, IRAP frame, non-IRAP frame) can be defined in a similar way.

A sixth option for defining an RTP header-based condition may include using RTP packets of a same timestamp and payload type to identify an ADU. This option, which may be especially useful for video traffic, may be used to determine the ADU borders (for example, the starting and ending packet of an ADU). In some instances, this option may be used with the first option to identify both the ADU type and the ADU border (start/end).

For example, RTP packets that belong to the same video frame will have, by definition, the same timestamp and payload type. The timestamp may be allocated by the application at the sender and will not change throughout the transmission through the network to the receiver. In some instances, a network node may temporarily buffer or memorize the timestamps of older packets even after a marker bit was received. This may account for the possibility of out-of-order packet reception. By catching the timestamp for a period of time at the node or UE, any packets arriving late (or early) can still be associated with the same ADU.

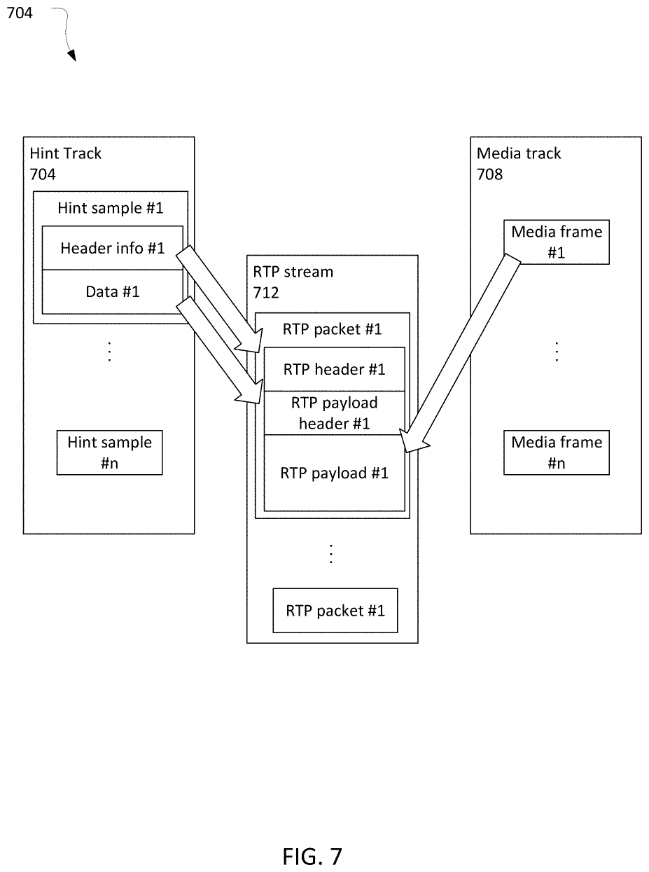

A seventh option for defining an RTP header-based condition may include the use of an associated hint track. FIG. 7 illustrates a hint track 704 that is mapped to a dedicated traffic stream (media track 708) that is transmitted in parallel. The media track 708 may have the real media data (as media frames #1-#n) and the hint track 704 may include meta/control information (as hint samples #1-#n) that may be used for data representation of corresponding media frames. For example, the meta/control information of the hint track 704 may provide media transmission instructions that can be used, in conjunction with the media track 708 to record an RTP stream 712 into a file. Synchronization of the hint track 704 to the media track 708 can be achieved through, for example, timestamps contained in the respective tracks. This assumes that the relation between the two tracks is known/configured. The sender may also insert a timestamp in the RTP header to facilitate processing of the packet at the receiver.

The hint track 704 may include a plurality of hint samples that respectively correspond to a plurality of frames of the media track 708. The hint samples may be similar to a payload header and a payload with a simple but flexible format that may be predefined or configured by separate signaling. A hint sample may be used to identify the overall payload format of an ADU or to include extra information.

A transmitting device may generate an RTP packet based on a corresponding hint sample and media frame. The hint sample may have header information to be used to generate the RTP header of the RTP packet and data to be used to generate an RTP payload header of the RTP packet. The data of the hint sample may be encrypted. Information on how to treat and decrypt the data may be separately signaled to a server via session description protocol (SDP), for example. The information to facilitate decryption may be additionally/alternatively indicated in the hint track itself or otherwise available in the core network and provided from the PCF/AF to the SMF 114 and then populated down to UPF 112 or UE 104. The RTP payload of the RTP packet may be generated based on the media frame. The hint sample may also include information to facilitate the generation of the RTP payload based on the media frame.

The hint track may be generated with a specified format as part of a 3GP file format. For example, the hint track 704 may be an RTP/SRTP hint track defined consistent with details provided in ISO/IEC standard 14496-12:2020(E): Information technology—Coding of audio-visual objects—Part 12: ISO base media file format or 3GPP TS 26.244 v16.1.0 (2020-09) for aspects pertaining to end-to-end packet switched streaming. TS 26.244 defines a hint-track extension of the 3GP file format called “3gau.”

The seventh option may include using the hint track to provide meta information of ADU borders, type, etc. For example, the header information from the hint track/sample associated with an RTP packet may be used to provide information about the ADU to which the RTP packet belongs. The header information may include a start/end marker or a PNU as described with respect to previous options.

While FIG. 7 illustrates the hint track 704 being mapped to the parallel media track 708, the ADU-mapping information may be provided through a hint track/sample in a variety of other ways in other embodiments. For example, a hint track may be a separate RTP stream that just has the hint track data as the payload. The RTP stream having the hint track would then be associated with the RTP stream having the ADU packets. The association may be preconfigured, based on timestamps, etc.

Additionally/alternatively, the hint track/samples (and ADU-mapping information conveyed thereby) may be sent as in-band control information in the same file as the media information. The hint samples may be transmitted as separate RTP packets on the same IP flow as the packets of the ADU. This may be analogous to a special control packet; however, the description comes from the application layer itself (as part of the 3GP file, in the form of a hint sample). The RTP timestamp of the hint samples could correlate with other related data packets. In another example, an RTP header extension could be used to indicate that a packet belongs to a hint track of a specified format. The actual hint track data might be a part of the payload itself.

The eighth option for defining an RTP header-based condition may be based on predefined packetization rules to which an application layer is to adhere in generating an RTP stream. These packetization rules may ensure separation of ADUs. For example, the packetization rules may specify that coded pictures (or certain ADU types) are to be encoded into individual segments, where a slice corresponds to such a segment. In another example, the packetization rules may ensure that one ADU is carried by a predefined number of RTP packets. The predefined number may be one or more.

Definition of the RTP header-based condition based on the packetization rules may depend on the how an ADU is structured for a particular application. For example, XR streams may use codecs and ADU structures both similar to, and different from, those used with typically video/audio streams. In addition to additional codecs/ADU structures, XR streams may include those for control types of information (such as scene, pose data, immersive data, etc.).

The features described in the eight options above for RTP header-based conditions may be used for constructing a packet filter (for example, QoS rule, PDR, or PCC rule) to detect traffic. In some embodiments, an application function/server in a network may indicate RTP header information suitable for traffic detection to other network elements/functions. In this manner, information relevant to traffic detection may be disseminated throughout a network.

An RTP payload-based condition for a packet filter set may be defined by one or more of the following three options. Aspects of these options may be used separately or combined with aspects of other options as desired for a particular embodiment.

A first option for defining an RTP payload-based condition may include parsing the RTP payload header in order to obtain detailed ADU type information (for example, the frame/slice type of the ADU). A packet filter may include a description that defines which header fields of a payload header may be used to provide respective information for ADU type mapping. A device may parse those header fields of a packet to look for specific content that, if found, may be used to map the packet to a QoS flow or to identify an ADU. The RTP payload header may be defined in “RTP payload format” RFCs such as, for example, RFC 6184 and RFC 7798. These RFCs may be updated to define the RTP payload header with an ADU type field. A value of the ADU type field may then be used to indicate the type of the ADU with which an RTP packet is associated.

Information about the ADU borders (ADU start/end or PNU) may also be derived from the payload header. For example, the payload header may be defined to include a start/end/PNU field that may be populated with a value to provide corresponding information.

A second option for defining an RTP payload-based condition may include parsing the RTP payload header to determine when a current ADU ends and a new ADU starts. This may be accomplished using the RTP payload format RFCs.

If the RTP header already carries information about the start/end of an ADU (for example, as described with respect to the second option of the RTP header-based condition), then the information in the RTP header may be used instead of the information from the RTP payload header.

A third option for defining an RTP payload-based condition may include using an RTP hint track to indicate the ADU mapping information such as, for example, an ADU type, an ADU start/end, format, size, etc.

In an embodiment, a hint track can be mapped to a dedicated RTP stream (for example, IP flow) that is transmitted in parallel to the target user data stream (for example, ADUs) as meta-information or control information that may be used for data representation. The dedicated RTP stream may carry the hint tracks only. Synchronization may be achieved through, for example, the RTP timestamp contained in the RTP packet. This may assume that the relationship between the data stream carrying the hint track is known (configured) with respect to the target user data stream to which the meta-information belongs.

In another embodiment, the meta-information from a hint track (or sample) may be sent in a separate RTP packet (in the payload) in the same IP flow that also carries normal ADU data packets. For example, the first or last packet of an ADU may start (or end) with a data portion in the payload carrying the hint track. As the structure in formatted hint track is known (signaled or specified) in advance, the position where to find this data in the payload can be derived, or the RTP header may carry an indication to denote presence of the track.

Using the hint track may be advantageous as it may be flexibly extended to include extra meta-information to describe the ADU. While this option provides some flexibility for communicating the desired information, it may also involve additional computational complexity due to the amount of payload parsing needed to access the data in the RTP hint track.

An RTCP header-based condition for a packet filter set may be defined as follows. If an RTCP packet is detected, this packet can be mapped separately since RTCP packets are associated with additional protection. Therefore, an RTCP packet may either go to a dedicated QoS flow or share a QoS flow that receives comparable forwarding treatment.

The features described in the options above for RTP/RTCP header- or payload-based conditions may be used for constructing a packet filter (for example, QoS rule, PDR, or PCC rule) to detect traffic. In some embodiments, an application function/server in a network may indicate RTP header/payload information suitable for traffic detection to other network elements/functions. In this manner, information relevant to traffic detection may be disseminated throughout a network.

Principles similar to those discussed above for ADU-based QoS mapping for RTP/MTSI streams may also be applied for ADU-based QoS mapping for SRTP streams as follows.

For SRTP-based services (for example, WebRTC and streaming), the packet filter set may be extended by an additional set of packet filters. For example, the packet filter set may support packet filters based on any combination of: source/destination IP address or IPv6 prefix; source/destination port number; protocol ID of the protocol above IP/next header type; a TOS (IPv4) or traffic class (IPv6) and mask; a flow label (IPv6); a security parameter index; a packet filter direction; an SRTP header-based condition; an SRTP payload-based condition; or an SRTCP header-based condition. The last three packet filters (SRTP header-based condition, SRTP payload-based condition, and SRTCP header-based condition) may be considered additional filters that may be used, in any combination, to enable the ADU-based QoS mapping for SRTP streams.

An SRTP header-based condition for a packet filter set may be defined by one or more of the following eight options. Aspects of these options may be used separately or combined with aspects of other options as desired for a particular embodiment.

A first option may define a set of ADU types in an RTP header extension of an SRTP packet. The set of ADU types may be defined using the header extension mechanism of RFC 3550 or the policy of RFC 3551, section 3. In some aspects, this option may be extended to define a structure that adds a set of parameters with information that describes an ADU. As a result, data traffic may indicate, in a header extension of the SRTP packet, a value of a type of ADU with which the packet is associated. The ADU type value may indicate a specific frame or slice type. For example, the ADU type value may indicate that the associated ADU is an I frame/slice, a P frame/slice, a B frame/slice, an S frame/slice, an SI frame/slice, an SP frame/slice, an IDR frame, a non-IDR frame, an IRAP frame, a non-IRAP frame, or a type of reference frame.

In some embodiments, a value of the header extension may be used together with a PT value, which indicates the codec type (for example, H263, H264, H265, etc.), to determine the ADU type. For example, the header extension value may correspond to a generic ADU type, and a device may determine a specific ADU type with additional reference to the codec type indicated by the PT value.

The first option does not require parsing of the payload header in the encrypted SRTP payload to get the detailed ADU information for all frame/slice types.

A second option for defining an SRTP header-based condition may be based on a marker bit in the RTP header of the SRTP packet that identifies a first or last packet associated with an ADU. The marker bit may be assumed to be set for the first or last SRTP packet associated with an ADU. In this manner, the set marker bit may act as a delimiter that a device may rely on to identify the SRTP packets associated with a particular ADU. The interpretation of the marker bit may be defined by a profile in, for example, RFC 3550, RFC 3551, RFC 6184, or 7798.

A third option for defining an SRTP header-based condition may be based on an additional marker bit provided in an RTP extension header of the SRTP packet. This may be done consistent with the options provided in RFC 3550. The additional marker bit may be designed to complement the marker bit of the second option. For example, if the marker bit in the RTP header of the SRTP packet identifies a last packet associated with an ADU, the marker bit in the RTP extension header of the SRTP packet may be used to identify a first packet associated with the ADU. Conversely, if the marker bit in the RTP header of the SRTP packet identifies a first packet associated with an ADU, the marker bit in the RTP extension header of the SRTP packet may be used to identify the last packet associated with the ADU. Setting marker bits to define both the first and last packet may facilitate faster identification and forwarding of packets pertaining to an ADU. This may be especially useful in scenarios in which an ADU may contain many SRTP/IP packets and the traffic is associated with a low-latency objective.

A fourth option for defining an SRTP header-based condition may be based on a PNU field in an RTP extension header of the SRTP packet. This may be done consistent with options provided in RFC 3550. The PNU field of an SRTP packet may have value that indicates the number of the SRTP packet within the ADU. In one aspect, a first packet of an ADU may start with a PNU value of “1,” which may be incremented in subsequent packets. This aspect may be used instead of using the marker to indicate the first packet as described above with respect to the second and third options. In another aspect, a first packet of an ADU may start with a PNU value set to the total number of SRTP packets in the ADU and may be decremented for each subsequent packet until the PNU value of “1” is reached in the last SRTP packet of the ADU. In another option of this aspect, a first packet of an ADU may start with a PNU value set to one less than the total number of SRTP packets in the ADU and may be decremented for each subsequent packet until the PNU value of “0” is reached in the last SRTP packet of the ADU. This aspect may be advantageous as a device will know upon receipt of the first or subsequent packet how many additional SRTP packets to expect for the ADU. This aspect may be used instead of using the marker to indicate the last packet as described above with respect to the second and third options.

In some instances, the PNU value and the marker bit indicating the first or last packet may be used together. For example, if the PNU values increase, the marker bit may be used to indicate the last packet in the ADU. Conversely, if the PNU values decrease, the marker bit may be used to indicate the first packet in the ADU. If in-sequence delivery is assured and the marker bit as used instead of the PNU value for the first packet, the first PNU value, in the second packet of the ADU, may be set with one less than the total number of SRTP packets in the ADU. Alternatively, the marker bit may be used together with the PNU value in the same (for example, first) packet

In some aspects, only one SRTP packet may be provided with a PNU value. The one SRTP packet may be the first SRTP packet or the last SRTP packet. For example, a first SRTP packet may be provided with a PNU value that is equal to the total number of SRTP packets in an ADU. This may be used instead of the first marker. Thus, in addition to providing a delimiter, the PNU value may also provide a device with information as to a total number of SRTP packets in the ADU.

A fifth option for defining an SRTP header-based condition may be accomplished by defining a new payload type for ADUs of a same codec type but for different frame types. This may be done by using at least one of the following suboptions. In a first suboption, the new payload type may be defined by using a profile-specific modification to an RTP header of the SRTP packet as defined in, for example, RFC 3550, clause 5.3. In a second suboption, the new payload type may be defined by using payload types in the value range 96-127 dynamically defined through a suitable signaling protocol during communication establishment as defined in, for example, RFC 3551, clause 6. In a third suboption, the new payload type may be defined via a header extension similar to that described above with respect to the first option.

For example, a new payload type “H.264_key_frame” may be defined in addition to the existing H.264 payload format. Other ADU types (for example, IDR frame, non-IDR-frame, IRAP frame, non-IRAP frame) can be defined in a similar way.

A sixth option for defining an SRTP header-based condition may include using SRTP packets of a same timestamp and payload type to identify an ADU. This option, which may be especially useful for video traffic, may be used to determine the ADU borders (for example, the starting and ending packet of an ADU). In some instances, this option may be used with the first option to identify both the ADU type and the ADU border (start/end).

For example, SRTP packets that belong to the same video frame will have the same timestamp by definition. The timestamp may be allocated by the application at the sender and will not change throughout the transmission through the network to the receiver. In some instances, a network node may temporarily buffer or memorize the timestamps of older packets even after a marker bit was received. This may account for the possibility of out-of-order packet reception. By catching the timestamp for a period of time at the node or UE, any packets arriving late (or early) can still be associated with the same ADU.

A seventh option for defining an SRTP header-based condition may include using a hint track to provide meta information of ADU borders, type, etc. For example, the header information from the hint track/sample associated with an SRTP packet may be used to provide information about the ADU to which the SRTP packet belongs. The format and use of the hint track that conveys the ADU information may be similar to any of the examples described above with respect to the RTP header-based condition embodiments. The header information may include a start/end marker or a PNU as described with respect to previous options.

The eighth option for defining an SRTP header-based condition may be based on predefined packetization rules to which an application layer is to adhere in generating an SRTP stream. These packetization rules may ensure separation of ADUs. For example, the packetization rules may specify that coded pictures (or certain ADU types) are to be encoded into individual segments, where a slice corresponds to such a segment. In another example, the packetization rules may ensure that one ADU is carried by a predefined number of SRTP packets. The predefined number may be one or more.

Definition of the SRTP header-based condition based on the packetization rules may depend on the how an ADU is structured for a particular application. For example, XR streams may use codecs and ADU structures both similar to, and different from, those used with typically video/audio streams. In addition to additional codecs/ADU structures, XR streams may include those for control types of information (such as scene, pose data, immersive data, etc.).

The features described in the eight options above for SRTP header-based conditions may be used for constructing a packet filter (for example, QoS rule, PDR, or PCC rule) to detect traffic. In some embodiments, an application function/server in a network may indicate SRTP header information suitable for traffic detection to other network elements/functions. In this manner, information relevant to traffic detection may be disseminated throughout a network.

As SRTP encrypts the RTP payload, but not the header, embodiments for ADU-based QoS mapping for SRTP streams focus on the header. However, in some embodiments, an SRTP payload-based condition for a packet filter set may be defined based on a hint track. For example, an SRTP hint track can be used to indicate ADU mapping information (for example, ADU type, ADU start/end, format, and size). While this option provides some flexibility for communicating the desired information, it may also involve additional computational complexity due to the amount of payload parsing needed to access the data in the RTP hint track.

An SRTCP header-based condition for a packet filter set may be defined as follows. If an SRTCP packet is detected, this packet can be mapped separately since SRTCP packets are associated with additional protection. Therefore, an SRTCP packet may either go to a dedicated QoS flow or share a QoS flow that receives comparable forwarding treatment.

The features described in the options above for SRTP/SRTCP header- or payload-based conditions may be used for constructing a packet filter (for example, QoS rule, PDR, or PCC rule) to detect traffic. In some embodiments, an application function/server in a network may indicate SRTP header/payload information suitable for traffic detection to other network elements/functions. In this manner, information relevant to traffic detection may be disseminated throughout a network.

Providing extra information to the AN 108 may enable beneficial traffic detection at the RAN level in accordance with some embodiments. ADU rules for traffic detection may be provided to the AN 108 if the determination of packets associated with an ADU does not happen in the UPF 112 or if the AN 108 would otherwise benefit from awareness of the ADU rules. The ADU rules may correspond to traffic detection rules or application layer attributes such as, for example, QoS flow association, frame-level QoS, ADU-based QoS, or XR specific QoS. These ADU rules may include packet filters to detect ADUs based on RTP/SRTP contents as described elsewhere herein.

In addition to distinguishing different frame types (for example, distinguishing an I frame from a P frame), a scheduler of the AN 108 may increase the efficiency over the access network given knowledge of ADU information. For example, the scheduler may make scheduling/segmentation/concatenation decisions based on the start of a new ADU. This may be the case even if the previous ADU was of a similar type (for example, both the previous ADU and the present ADU are P frames). For example, if only a few bits are missing to complete the ADU, the scheduler may allocate more resources in a transmission time interval (TTI) n, but might take more time to schedule subsequent bits belonging to the next ADU in TTI n+1.

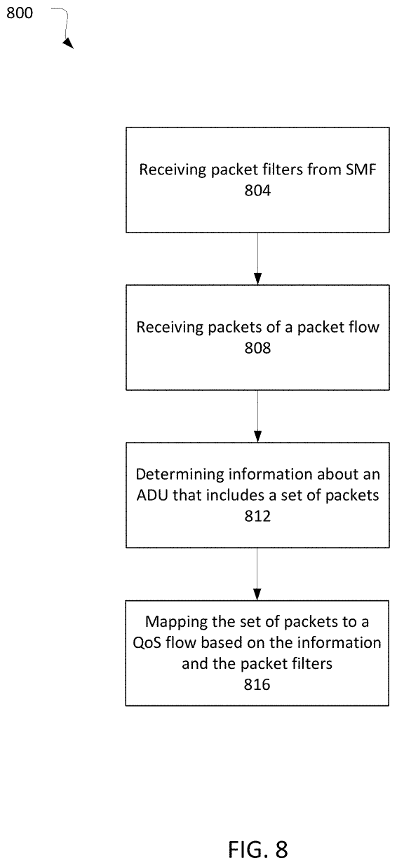

FIG. 8 illustrates an operation flow/algorithmic structure 800 in accordance with some embodiments. The operation flow/algorithmic structure 800 may be performed by a network node such as, for example, UE 104, UE 1100, UPF 112, or network node 1200, or components thereof, for example, processors 1104 or 1204.

The operation flow/algorithmic structure 800 may include, at 804, receiving packet filters from an SMF. The packet filters may provide rules that allow the network node to perform traffic detection and QoS management as described elsewhere herein. In some embodiments, the packet filters may include an RTP/SRTP header-based condition, an RTP/SRTP payload-based condition, or an RTCP/SRTCP header-based condition. In an embodiment in which the operation flow/algorithmic structure 800 is performed by a UE, the packet filters may be received as QoS rules. In an embodiment in which the operation flow/algorithmic structure 800 is performed by a UPF, the packet filters may be received as PDRs.

The operation flow/algorithmic structure 800 may further include, at 808, receiving packets of a packet flow. In some embodiments, each packet of the packet flow may correspond to an RTP/SRTP packet or an RTCP/SRTCP packet. The packet flow may be for application services such as, for example, XR or immersive multimedia services, or any other type of services.

The operation flow/algorithmic structure 800 may further include, at 812, determining information about an ADU that includes a set of packets. In some embodiments, the information determined at 812 may indicate a frame/slice type of the ADU. In other embodiments, the information determined at 812 may indicate that the set of packets are within the ADU. This may be accomplished by providing a start/end marker in a first/last packet of the ADU or a PNU value in one or more of the packets. In some embodiments, the indication that the set of packets are within the ADU may be based on, the set having a common timestamps and payload type. In some embodiments, the information determined at 812 may be based on a hint track associated with the packet flow or packetization rules it hereto by the source application layer.

The information about the ADU may be conveyed through one or more of the packets of the set. For example, the information may be conveyed through RTP/SRTP/RTCP/SRTCP headers/payloads as described elsewhere herein.

The operation flow/algorithmic structure 800 may further include, at 816, mapping the set of packets to a QoS flow based on the information and the packet filters. In some embodiments, packets of the packet flow corresponding to different ADUs may be mapped to different QoS flows. In other embodiments, packets of the packet flow corresponding to different ADUs may be mapped to the same QoS flow, but may be marked in a manner to indicate the packets are associated with the different ADUs. This marking may be in a user plane header of the packets.

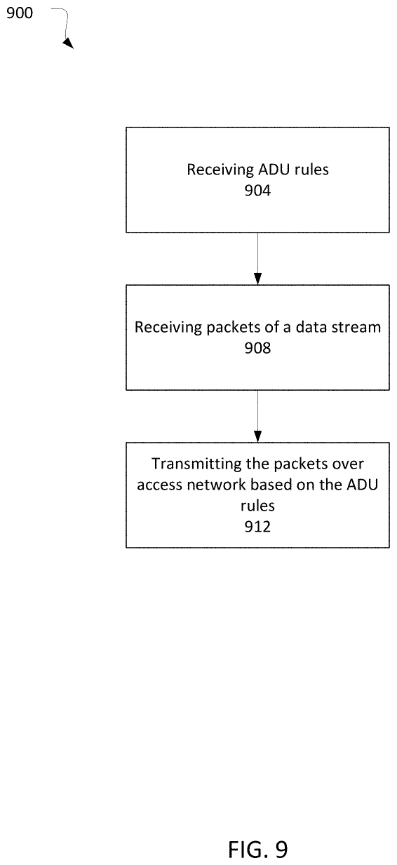

FIG. 9 illustrates an operation flow/algorithmic structure 900 in accordance with some embodiments. The operation flow/algorithmic structure 900 may be performed by an such as, for example, AN 108 or network node 1200 or components thereof, for example, processors 1204.

The operation flow/algorithmic structure 900 may include, at 904, receiving ADU rules. The ADU rules may be received, directly or indirectly, from an SMF and may comprise packet filters with traffic detection rules or application layer attributes. The ADU rules may comprise QoS routing information relevant to packets of a data flow. The QoS routing information may include a QoS flow association, a frame-level QoS, and ADU-based QoS, or an XR-specific QoS. The ADU rules may additionally/alternatively enable the AN to determine ADU types and packets that are associated with particular ADUs.

The operation flow/algorithmic structure 900 may further include, at 908, receiving packets of the data stream. The packets may be RTP/SRTP packets that carry audio data, video data, or other types of application data.

The operation flow/algorithmic structure 900 may further include, at 912, transmitting the packets over an access network based on the ADU rules. For example, the AN may identify a set of packets of an ADU and a type of the ADU and may perform scheduling/segmentation/concatenation decisions with respect to the set based on the membership of the set and the ADU type.

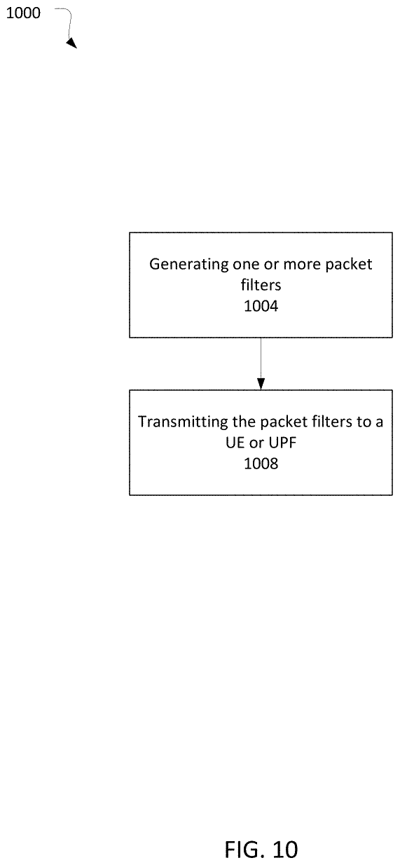

FIG. 10 illustrates an operation flow/algorithmic structure 1000 in accordance with some embodiments. The operation flow/algorithmic structure 1000 may be performed by an SMF such as, for example, SMF 114, network node 1200, or components thereof, for example, processors 1204.

The operation flow/algorithmic structure 1000 may include, at 1004, generating one or more packet filters. The packet filters may be generated by binding PCC rules (obtained from a PCF) to QoS flows based on the QoS and service requirements. The packet filters may facilitate identification of information corresponding to an ADU that includes one or more packets of the data stream. The information may enable a network node to identify a type of the ADU and packets that belong to the ADU.

The operation flow/algorithmic structure 1000 may further include, at 1008, transmitting the packet filters to a UE or UPF. If the packet filters are transmitted to the UE, they may be transmitted as QoS rules. If the packet filters are transmitted to the UPF, they may be transmitted as PDRs.

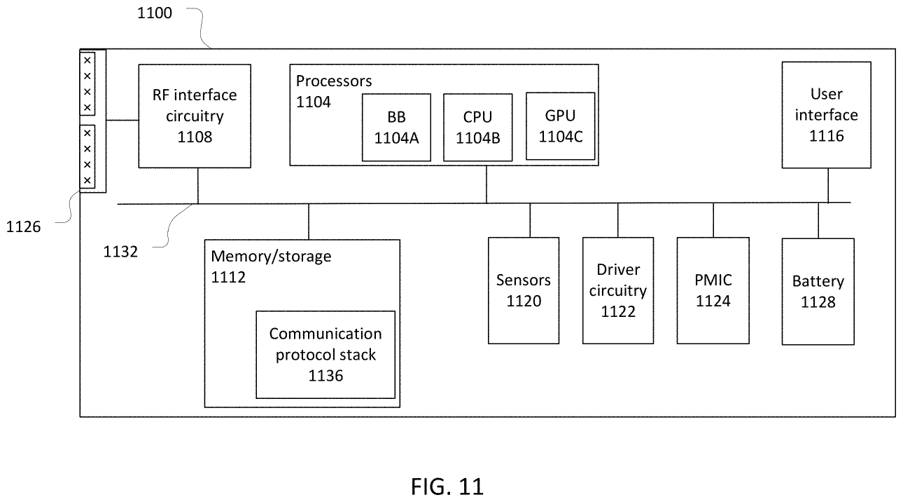

FIG. 11 illustrates a UE 1100 in accordance with some embodiments. The UE 1100 may be similar to and substantially interchangeable with UE 104 of FIG. 1.

The UE 1100 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1100 may include processors 1104, RF interface circuitry 1108, memory/storage 1112, user interface 1116, sensors 1120, driver circuitry 1122, power management integrated circuit (PMIC) 1124, antenna structure 1126, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1132, which may represent any type of interface, input/output, bus (local, system, or expansion), transmission line, trace, or optical connection that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack 1136 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, communication protocol stack 1136) that may be executed by one or more of the processors 1104 to cause the UE 1100 to perform various operations described herein. The memory/storage 1112 include any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1108 may include transceiver circuitry and radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1126.

In various embodiments, the RF interface circuitry 1108 may be configured to transmit/receive signals in a manner compatible with NR access technologies.

The antenna structure 1126 may include antenna elements to convert electrical signals into radio waves to travel through the air and to convert received radio waves into electrical signals. The antenna elements may be arranged into one or more antenna panels. The antenna structure 1126 may have antenna panels that are omnidirectional, directional, or a combination thereof to enable beamforming and multiple input, multiple output communications. The antenna structure 1126 may include microstrip antennas, printed antennas fabricated on the surface of one or more printed circuit boards, patch antennas, or phased array antennas. The antenna structure 1126 may have one or more panels designed for specific frequency bands including bands in FR1 or FR2.

The user interface 1116 includes various input/output (I/O) devices designed to enable user interaction with the UE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of the sensors 1120 and control and allow access to the sensors 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the UE 1100 including DRX as discussed herein.

A battery 1128 may power the UE 1100, although in some examples the UE 1100 may be mounted deployed in a fixed location, and may have a power supply coupled to an electrical grid. The battery 1128 may be a lithium-ion battery, a metal-air battery, such as a zinc-air battery, an aluminum-air battery, a lithium-air battery, and the like. In some implementations, such as in vehicle-based applications, the battery 1128 may be a typical lead-acid automotive battery.

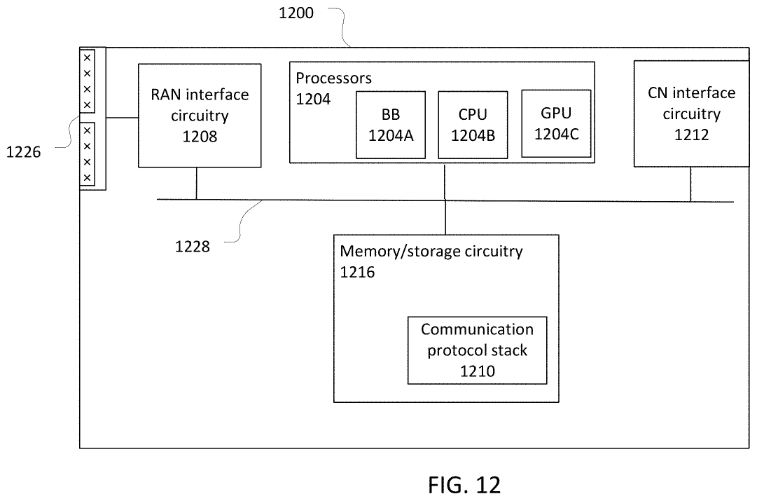

FIG. 12 illustrates a network node 1200 in accordance with some embodiments. The network node 1200 may be similar to and substantially interchangeable with access node 108, UPF 112, or SMF 114 of FIG. 1.

The network node 1200 may include processors 1204, RF interface circuitry 1208 (if implemented as an access node), core network (CN) interface circuitry 1212, memory/storage circuitry 1216, and antenna structure 1226 (if implemented as an access node).

The components of the network node 1200 may be coupled with various other components over one or more interconnects 1228.

The processors 1204, RF interface circuitry 1208, memory/storage circuitry 1216 (including communication protocol stack 1210), antenna structure 1226, and interconnects 1228 may be similar to like-named elements shown and described with respect to FIG. 11. If the network node 1200 is implemented as an access node, the communication protocol stack 1210 may include access stratum layers. If the network node 1200 is implemented as a device in a core network, for example, as a UPF or SMF, the communication protocol stack 1210 may include a NAS layer.

The CN interface circuitry 1212 may provide connectivity to a core network, for example, a 5^{th} Generation Core network (5GC) using a 5GC-compatible network interface protocol such as carrier Ethernet protocols, or some other suitable protocol. Network connectivity may be provided to/from the network node 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

In some embodiments, the network node 1200 may be coupled with transmit receive points (TRPs) using the antenna structure 1226, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a network node, the method comprising: receiving, from a session management function (SMF), one or more packet filters; receiving a plurality of packets of a packet flow; and determining information about an application data unit (ADU) that includes a set of one or more packets of the plurality of packets; and mapping the set of one or more packets to a quality of service (QoS) flow based on the information and the one or more packet filters.

Example 2 includes the method of example 1 or some other example herein, further comprising: determining, based on the information, a type of the ADU or that the set of one or more packets are included in the ADU.

Example 3 includes the method of example 1 or some other example herein, wherein the set of one or more packets is a first set, the information is first information, the QoS flow is a first QoS flow, the ADU is a first ADU, and the method further comprises: determining second information about a second ADU that includes a second set of one or more packets of the plurality of packets; and mapping the second set of one or more packets to a second QoS flow based on the second information and the one or more packet filters.

Example 4 includes the method of example 1 or some other example herein, wherein the set of one or more packets is a first set of one or more packets, the ADU is a first ADU, and the method further comprises: adding first user plane (UP) header markings to the first set of one or more packets to indicate correspondence to the first ADU; determining a second set of one or more packets of the plurality of packets corresponds to a second ADU; and adding second UE header markings to the second set of one or more packets to indicate correspondence to the second ADU.

Example 5 includes the method of example 1 or some other example herein, further comprising: determining the information about the ADU based on a real-time protocol (RTP) header, an RTP payload, an SRTP payload, a real-time control protocol (RTCP) header, or a secure RTCP (SRTCP) header of a packet of the set of one or more packets, wherein the packet is an RTP packet, an SRTP packet, an RTCP packet, or an SRTCP packet.

Example 6 includes a method of example 5 or some other example herein, wherein determining the information about the ADU is based on an RTP header of an RTP packet or an SRTP packet and the method further comprises: processing an RTP header extension of the RTP packet or the SRTP packet to determine one or more parameters that describe the ADU; and determining a type of the ADU based on the one or more parameters.

Example 7 includes the method of example 6 or some other example herein, wherein the type comprises: an intra-coded picture (I) frame or slice, a predicted picture (P) frame or slice, a bidirectional predicted picture (B) frame or slice, a switching (S) frame or slice, a switching I (SI) frame or slice, a switching P (SP) frame or slice, an instantaneous decoding refresh (IDR) frame, a non-IDR frame, an intra-random access picture (IRAP) frame, or a non-IRAP frame.

Example 8 includes the method of example 5 or some other example herein, wherein determining the information about the ADU is based on a marker bit in an RTP header of an RTP/SRTP packet of the set of one or more packets, wherein the marker bit indicates the RTP/SRTP packet is a first packet of the set of one or more packets or a last packet of the set of one or more packets.

Example 9 includes the method of example 8 some other example herein, wherein the RTP/SRTP packet is a first RTP/SRTP packet, the marker bit is a first marker bit to indicate the first RTP/SRTP packet is a first packet of the set of one or more packets and determining the information about the ADU is based further on a second marker bit in an RTP header of a second RTP/SRTP packet that indicate the second RTP/SRTP packet is last packet of the set of one or more packets.

Example 10 includes a method of example 5 or some other example herein, wherein a first packet of the set of one or more packets includes a packet number in unit (PNU) field having a value to indicate an order of the first packet within the set of one or more packets of the ADU.

Example 11 includes the method of example 5 or some other example herein, wherein determining the information about the ADU is based on an RTP header of an RTP packet or an SRTP packet header and the method further comprises: detecting a value in a payload type field of the RTP header; and determining a type of the ADU based on the value.

Example 12 includes a method of example 5 or some other example herein, wherein individual packets of the set of one or more packets are RTP/SRTP packets that include common timestamps and payload types in respective RTP headers and the method comprises: determining the set of one or more RTP/SRTP packets corresponds to the ADU based on the common timestamps and payload types in the respective RTP headers.

Example 13 includes the method of example 5 or some other example herein, wherein determining the information about the ADU is based on an RTP header of an RTP/SRTP packet and the method further comprises: identifying a predetermined packetization rule implemented at an application layer; and determining the set of one or more packets corresponds to the ADU based on the predetermined packetization rule.

Example 14 includes the method of example 5 or some other example herein, wherein determining the information about the ADU is based on an RTP payload and the method further comprises: parsing an RTP payload header of the RTP payload to determine the information, wherein the information includes a type of the ADU, a starting packet of the ADU, or an ending packet of the ADU.

Example 15 includes the method of example 5 or some other example herein, wherein determining the information about the ADU is based on an RTCP header or an SRTCP header and the QoS flow is dedicated to the set of one or more packets or is shared with additional packets that have packet forwarding treatment common with the set of one or more packets.

Example 16 includes the method of example 1 or some other example herein, further comprising: receiving a hint track associated with the packet flow; and determining the information about the ADU based on the hint track.

Example 16 includes the method of example 1 or some other example herein, wherein the network node is a user plane function (UPF) and the one or more packet filters comprise packet detection rules.

Example 18 includes a method of example 1 or some other example herein, wherein the network node is a user equipment (UE) and the one or more packet filters comprise quality of service rules.

Example 19 includes a method of operating an access node (AN), the method comprising: receiving application data unit (ADU) rules; receiving a plurality of packets of a data stream in one or more quality of service (QoS) flows; and transmitting the plurality of packets over an access network based on the ADU rules.

Example 20 includes a method of example 19 or some other example herein, wherein the ADU rules comprise packet filters with traffic detection rules or application layer attributes.

Example 21 includes a method of example 19 or some other example herein, wherein the ADU rules comprise a QoS flow association, a frame-level QoS, an ADU-based QoS, or an extended reality (XR)-specific QoS.

Example 22 includes the method of example 19 or some other example herein, wherein the packets comprise real-time transport (RTP) packets or secure RTP (SRTP) packets.

Example 23 includes method of example 19 or some other example herein, further comprising: determining a set of one or more packets correspond to an ADU; and transmitting the set of one or more packets over the access network based on said determining the set of one or more packets correspond to the ADU.

Example 24 includes the method of example 23 or some other example herein, further comprising: determining a type of the ADU; and transmitting the set of one or more packets over the access network based on the type.

Example 25 includes a method of operating a session management function (SMF), the method comprising: generating one or more packet filters to facilitate identification of information corresponding to an application data unit (ADU) that includes one or more packets of a data stream; and transmitting the one or more packet filters to user plane function (UPF) or a user equipment (UE).

Example 26 includes a method of example 25 or some other example herein, wherein the information is to identify a type of the ADU or to identify the one or more packets of the data stream as belonging to the ADU.

Example 27 includes the method of example 25 or some other example herein, wherein: the one or more packet filters are quality of service (QoS) rules transmitted to the UE; or the one or more packet filters are packet detection rules transmitted to the UPF.

Example 28 may include an apparatus comprising means to perform one or more elements of a method described in or related to any of examples 1-27, or any other method or process described herein.

Example 29 may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Example 30 may include an apparatus comprising logic, modules, or circuitry to perform one or more elements of a method described in or related to any of examples 1-27, or any other method or process described herein.

Example 31 may include a method, technique, or process as described in or related to any of examples 1-27, or portions or parts thereof.

Example 32 may include an apparatus comprising: one or more processors and one or more computer-readable media comprising instructions that, when executed by the one or more processors, cause the one or more processors to perform the method, techniques, or process as described in or related to any of examples 1-27, or portions thereof.

Example 33 may include a signal as described in or related to any of examples 1-27, or portions or parts thereof.

Example 34 may include a datagram, information element, packet, frame, segment, PDU, or message as described in or related to any of examples 1-27, or portions or parts thereof, or otherwise described in the present disclosure.

Example 35 may include a signal encoded with data as described in or related to any of examples 1-27, or portions or parts thereof, or otherwise described in the present disclosure.

Example 36 may include a signal encoded with a datagram, IE, packet, frame, segment, PDU, or message as described in or related to any of examples 1-27, or portions or parts thereof, or otherwise described in the present disclosure.

Example 37 may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Example 38 may include a computer program comprising instructions, wherein execution of the program by a processing element is to cause the processing element to carry out the method, techniques, or process as described in or related to any of examples 1-27, or portions thereof.

Example 39 may include a signal in a wireless network as shown and described herein.

Example 40 may include a method of communicating in a wireless network as shown and described herein.

Example 41 may include a system for providing wireless communication as shown and described herein.

Example 42 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a network node, the method comprising:
receiving, from a session management function (SMF), one or more packet filters;
receiving a plurality of packets of a packet flow; and
determining information about an application data unit (ADU) that includes a set of one or more packets of the plurality of packets; and
mapping the set of one or more packets to a quality of service (QoS) flow based on the information and the one or more packet filters.

2. The method of claim 1, further comprising:
determining, based on the information, a type of the ADU or that the set of one or more packets are included in the ADU.

3. The method of claim 1, wherein the set of one or more packets is a first set, the information is first information, the QoS flow is a first QoS flow, the ADU is a first ADU, and the method further comprises:
determining second information about a second ADU that includes a second set of one or more packets of the plurality of packets; and
mapping the second set of one or more packets to a second QoS flow based on the second information and the one or more packet filters.

4. The method of claim 1, wherein the set of one or more packets is a first set of one or more packets, the ADU is a first ADU, and the method further comprises:
adding first user plane (UP) header markings to the first set of one or more packets to indicate correspondence to the first ADU;
determining a second set of one or more packets of the plurality of packets corresponds to a second ADU; and
adding second UE header markings to the second set of one or more packets to indicate correspondence to the second ADU.

5. The method of claim 1, further comprising:
determining the information about the ADU based on a real-time protocol (RTP) header, an RTP payload, an SRTP payload, a real-time control protocol (RTCP) header, or a secure RTCP (SRTCP) header of a packet of the set of one or more packets, wherein the packet is an RTP packet, an SRTP packet, an RTCP packet, or an SRTCP packet.

6. The method of claim 5, wherein determining the information about the ADU is based on an RTP header of an RTP packet or an SRTP packet and the method further comprises:
processing an RTP header extension of the RTP packet or the SRTP packet to determine one or more parameters that describe the ADU; and
determining a type of the ADU based on the one or more parameters,
wherein the type comprises: an intra-coded picture (I) frame or slice, a predicted picture (P) frame or slice, a bidirectional predicted picture (B) frame or slice, a switching (S) frame or slice, a switching I (SI) frame or slice, a switching P (SP) frame or slice, an instantaneous decoding refresh (IDR) frame, a non-IDR frame, an intra-random access picture (IRAP) frame, or a non-IRAP frame.

7. The method of claim 5, wherein:
determining the information about the ADU is based on a first marker bit in an RTP header of a first RTP/SRTP packet of the set of one or more packets and a second marker bit in an RTP header of a second RTP/SRTP packet of the set of one or more packets;
the first marker bit to indicate the first RTP/SRTP packet is a first packet of the set of one or more packets; and
the second marker bit to indicate the second RTP/SRTP packet is last packet of the set of one or more packets.

8. The method of claim 5, wherein a first packet of the set of one or more packets includes a packet number in unit (PNU) field having a value to indicate an order of the first packet within the set of one or more packets of the ADU.

9. The method of claim 5, wherein determining the information about the ADU is based on an RTP header of an RTP packet or an SRTP packet header and the method further comprises:
detecting a value in a payload type field of the RTP header; and
determining a type of the ADU based on the value.

10. The method of claim 5, wherein individual packets of the set of one or more packets are RTP/SRTP packets that include common timestamps and payload types in respective RTP headers and the method further comprises:
determining the set of one or more RTP/SRTP packets corresponds to the ADU based on the common timestamps and payload types in the respective RTP headers.

11. The method of claim 5, wherein determining the information about the ADU is based on an RTP header of an RTP/SRTP packet and the method further comprises:
identifying a predetermined packetization rule implemented at an application layer; and
determining the set of one or more packets corresponds to the ADU based on the predetermined packetization rule.

12. The method of claim 5, wherein determining the information about the ADU is based on an RTP payload and the method further comprises:
parsing an RTP payload header of the RTP payload to determine the information, wherein the information includes a type of the ADU, a starting packet of the ADU, or an ending packet of the ADU.

13. The method of claim 5, wherein determining the information about the ADU is based on an RTCP header or an SRTCP header and the QoS flow is dedicated to the set of one or more packets or is shared with additional packets that have packet forwarding treatment common with the set of one or more packets.

14. The method of claim 1, further comprising:
receiving a hint track associated with the packet flow; and
determining the information about the ADU based on the hint track.

15. The method of claim 1, wherein:
the network node is a user plane function (UPF) and the one or more packet filters comprise packet detection rules; or
the network node is a user equipment (UE) and the one or more packet filters comprise quality of service rules.

16. One or more non-transitory, computer-readable media having instructions that, when executed by one or more processors, cause an access node (AN) to:
receive application data unit (ADU) rules;
receive a plurality of packets of a data stream in one or more quality of service (QoS) flows; and
transmit the plurality of packets over an access network based on the ADU rules.

17. The one or more non-transitory, computer-readable media of claim 16, wherein the ADU rules comprise: packet filters with traffic detection rules or application layer attributes; a QoS flow association; a frame-level QoS; an ADU-based QoS; or an extended reality (XR)-specific QoS.

18. The one or more non-transitory, computer-readable media of claim 16, wherein the instructions, when executed, further cause the AN to:
determine a set of one or more packets correspond to an ADU of a type; and
transmit the set of one or more packets over the access network based on the type.

19. A device comprising:
memory with instructions; and
processing circuitry, coupled with the memory, the processing circuitry to execute the instructions to cause a session management function (SMF) to:
generate one or more packet filters to facilitate identification of information corresponding to an application data unit (ADU) that includes one or more packets of a data stream; and
transmit the one or more packet filters to user plane function (UPF) or a user equipment (UE).

20. The device of claim 19, wherein:
the information is to identify a type of the ADU or to identify the one or more packets of the data stream as belonging to the ADU;
the one or more packet filters are quality of service (QoS) rules transmitted to a UE; or
the one or more packet filters are packet detection rules transmitted to a UPF.
